(19) United States
(12) Patent Application Publication
(10) Pub. No.: US 2009/0219574 A1
(43) Pub. Date: Sep. 3, 2009

(54) System and method for the preparation of identification cards utilizing a self-service identification card station

(75) Inventors: Brett Cameron, Buda, TX (US); John McDavitt, San Marcos, TX (US); Charles Marchant, Dale, TX (US); David J. Oles, San Marcos, TX (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: DNP Photo Imaging America Corporation, San Marcos, TX (US)

(21) Appl. No.: 12/454,128

(22) Filed: May 13, 2009

Related U.S. Application Data
(63) Continuation-in-part of application No. 12/077,431, filed on Mar. 19, 2008.
(60) Provisional application No. 60/918,799, filed on Mar. 19, 2007.
(60) Provisional application No. 61/066,415, filed on Feb. 20, 2008.

(51) Int. Cl. G06F 3/12; G06F 3/041; H04Q 5/22; G05B 19/00

(52) U.S. Cl. 358/1.15; 345/173; 340/10.1; 340/5.82

(57) ABSTRACT

A self-service identification card station is disclosed providing a method for creating, customizing, and dispensing identification cards utilizing information provided by a purchaser about the intended identification card recipient. A purchaser may customize the identification card with the information the purchaser would like to include on the identification card. The self-service identification card station provides for the production of such customized identification cards from identification card blanks stored within the station that are printed with appropriate information on demand. The self-service identification station also allows the purchaser to customize the background of the cards. The self-service order station may be utilized in a retail outlet for public use or at a private location for employee use.

### CROSS-REFERENCE TO RELATED APPLICATIONS

This application claims the benefit under 35 U.S.C. § 119(e) of U.S. Provisional Application No. 61/127,436 entitled “GIFT CARD KIOSK-ID CARD,” filed on May 13, 2008. This application is a continuation-in-part under 35 U.S.C. § 120 of United States Non-Provisional patent application Ser. No. 12/390,149, entitled “METHOD AND SYSTEM FOR ADVERTISING ON A SELF-SERVICE ORDER STATION,” filed on Feb. 20, 2009, which claims priority of Provisional Application No. 61/066,415 entitled “GIFT CARD KIOSK,” filed on Feb. 20, 2008. This application also claims priority under 35 U.S.C. § 120 as a continuation-in-part application of U.S. patent application Ser. No. 12/077,431, entitled “GIFT CARD KIOSK,” filed Mar. 19, 2008, which claims priority from U.S. Provisional Application 60/918,799, entitled “GIFT CARD KIOSK,” filed Mar. 19, 2007. The above-referenced applications are incorporated herein by reference in their entireties.

### BACKGROUND OF THE INVENTION

1. Field of the Invention

The present invention relates to the field of card dispensers, and more particularly to a machine and method of dispensing customized identification cards.

2. Background

Historically, identification cards were created by printing the information on the card on a paper and then laminating the card with plastic compositions. With the ability to print information directly in plastic, identification cards can now be printed directly on plastic. Such plastic identification cards are not generally available to the public. It is not currently possible for an individual to customize and print an identification card at a retail outlet.

### SUMMARY OF THE INVENTION

One aspect of the present invention presents a self-service identification card station. The self-service identification card station includes a user interface; an identification card printer; a software program, stored in a computer readable medium, comprising instructions for implementing a method of creating and printing an identification card; and a processing unit communicably connected with the computer readable medium, the user interface, and the card printer. The processing unit is capable of implementing said software program, creating, customizing and printing identification cards for a customer.

Another aspect of the present invention consists of a method of creating and printing identification cards. The method consists of receiving identification information from a customer about an identification card recipient at a self-service identification card station; receiving biometric information from the identification card recipient at the self-service identification card station; printing the identification information and the biometric information on an identification card blank; presenting an identification card to the customer. In a further step, the self-service identification card station may encode the identification card recipient's information on a magnetic stripe on the card, a RFID Chip in the card, or a three dimensional bar code printed on the card.

On yet a further embodiment of the present invention, a system for creating and printing identification cards is presented. The system consists of a user interface; an identification card information database; a printing unit; and a processing unit communicatively connected with the user interface, the identification card information database and the printing unit. The system further allows access to the database to retrieve information saved on the identification card information database.

Other and additional objects of this invention will become apparent from a consideration of this entire specification.

### BRIEF DESCRIPTION OF THE DRAWINGS

FIG. 1 is a graphical depiction of an exemplary self-service identification card station in accordance with one exemplary embodiment of the present invention.

FIG. 2 is a graphical depiction of an exemplary gift card blank.

FIG. 3 is a flow chart of a method for creating and printing identification cards in accordance with one exemplary embodiment of the present invention.

FIG. 4 is a flow chart of a method for creating and printing identification cards in accordance with one exemplary embodiment of the present invention.

FIG. 5 is a block diagram of a system for creating and printing identification cards in accordance with one exemplary embodiment of the present invention.

### DETAILED DESCRIPTION

The invention summarized above and defined by the enumerated claims may be better understood by referring to the following description, which should be read in conjunction with the accompanying drawings in which like reference numbers are used for like parts. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

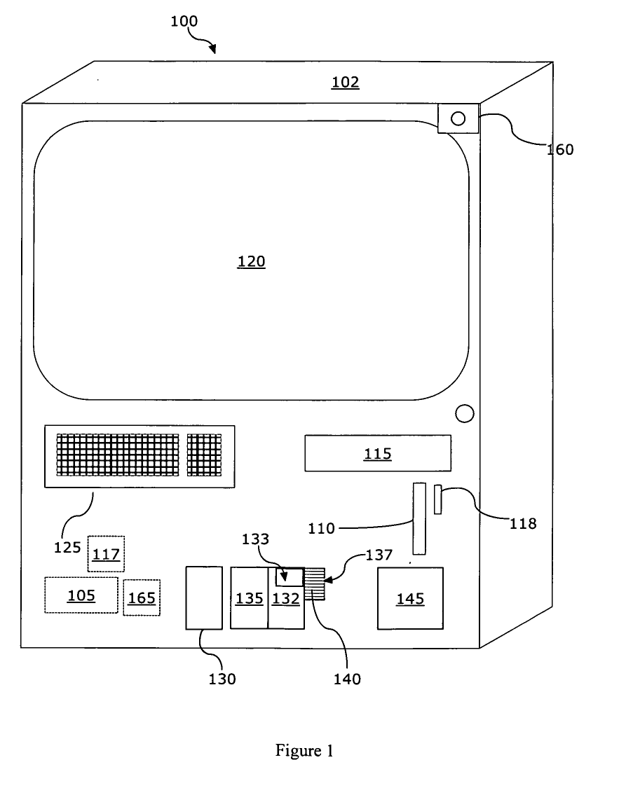

As shown in FIG. 1, a self-service identification card station 100 may be utilized for creating customized identification cards. The self-service identification card station may be utilized in a number of settings. By way of non-limiting example, the self-service identification card station may be located at a retail store allowing parents to create identification cards for their children. The self-service identification card station may also be utilized at a retail store to create identification cards for a group of individuals. The self-service identification card station may further be used as a gift card kiosk or in conjunction with a gift card/photo kiosk. The self-service identification card station may be placed at a company's human resources department to generate identification cards for employees and other authorized individuals.

The self-service identification card station 100 preferably comprises a processing unit 105, an identification card container 137, at least one identification card blank 140, an identification card printer 135, a user interface 120 (e.g., a touch screen display), a biometrics input device 160, and a media storage device 117. The self-service identification card station may also include a flash media reader 110, a CD/DVD drive 115 (preferably writeable), a computer keyboard 125, a receipt printer 130, an encoder 132, and a credit card/cash reader 145. It is contemplated that the self-service identification card station 100 may include all of the elements described above or as few of the elements as required to allow a customer to create an identification card.

The processing unit 105, communicatively connected to the components of the self-service identification card station, executes a software program embodied in a computer readable medium such as a media storage device 117 or a memory location 165. The software program provides instructions for the processing unit 105 to control each of the components of the self-service identification card station and for creating identification cards. The computer software program allows the self-service identification card station to present the purchaser with options to select, customize, pay for (if applicable) and retrieve identification cards from the self-service identification station. In some preferred embodiments, the software program may contain instructions for creating a database of individuals to whom identification cards have been issued. The processing unit 105 may be further connected to a network.

The user interface 120 facilitates communication between the user and the self-service identification station 100. An identification card purchaser may utilize a touch screen display 120, a keyboard 125, a video screen, or any other means contemplated by a person having ordinary skill in the art to enter the information and make the selections required. The user interface 120 may utilize thumbnail pictures, drop-down menus, radial buttons and other means contemplated by persons of ordinary skill in the art that allow a purchaser to make the required selections.

In some embodiments of the present invention, the identification card printer 135 includes an encoder 133 for magnetic stripes, RFID chips, and other devices used for the storage and retrieval of information. In other embodiments, the encoder 133 is a separate structure that encodes the magnetic stripe before or after the card blank is passed to the card printer that prints the personalized card images onto the card blank.

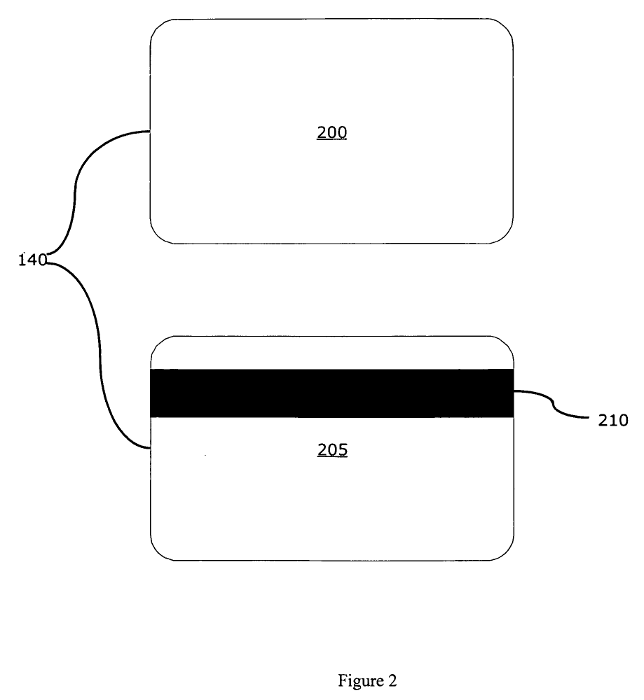

As shown in FIG. 2, the identification card blanks 140 are plastic cards with a front side 200 and a back side 205. On the back side 205, the card may include a magnetic stripe 210. The magnetic stripe 210 is capable of being encoded with appropriate identification card data at the time of purchase. In some embodiments, the cards may include a Radio Frequency Identification Chip (RFID Chip) instead of a magnetic stripe 210, which may be encoded with the information displayed on the card and other information the user may want to include with the card. The card blanks 140 may be constructed of plastic materials that have the ability of accepting colors and drawings from the identification card printer 135. A user may customize an identification card prior to purchase by, for example, selecting the layout of the information printed on the card, selecting the information to be printed on the card, selecting additional text to be printed on the card, selecting graphics (such as background figures and colors) to be printed on the card, and/or selecting the information to be encoded on the magnetic stripe 210, RFID Chip, three dimensional barcode, or similar device (whether or not it is printed on the card).

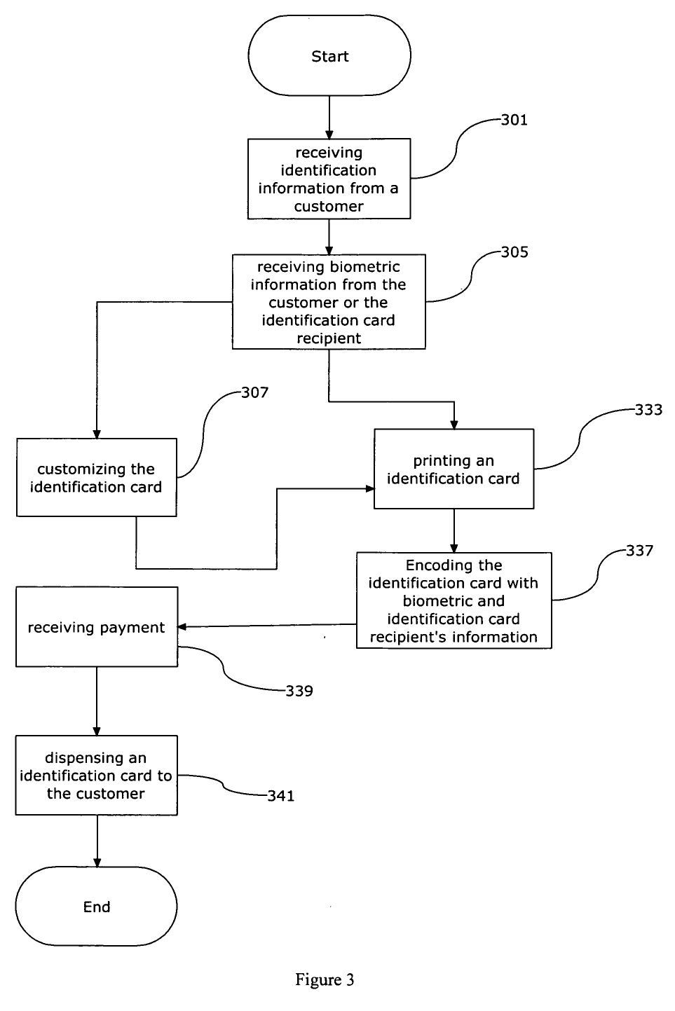

In one preferred embodiment, the self-service identification card station may be used at a retail store for creating identification cards used for informational purposes. For example, the self-service identification card station may be utilized to create identification cards for children. In a retail location, the software program of the self-service identification card station contains instructions to carry out the method of issuing identification cards shown on FIG. 3.

In the first step 301 of the method, the process of issuing an identification card begins. The self-serve identification card station receives identification information from a customer about an identification card recipient. In this first step 301, the user interface may present the user with an “Identification Card” button that a user may select to initiate the process. It is contemplated that the customer may be given the opportunity to upload a previously created template upon approaching the self-service identification card station. For example, in one such embodiment the customer may have two options: 1) create a new card or 2) create a new card from a template. If the customer selects the option to create a new card from a template he or she may further be presented with two additional options: 1) upload your own template or 2) select a template from a list. The list of templates available to the customer may include thumbnails showing different types of cards. Some of the cards may have basic information, some may include family information, and yet some others may include specific types of cards to be used for specific purposes. It is contemplated that the customer may be allowed to further customize the card once a template has been selected.

In step 301, the customer may provide the identification card recipient's name, gender, address, phone number, emergency contact's name and phone number, and any other information that the customer may want to display on the identification card or store in a database associated with the identification card. It is contemplated that the customer may be the identification card recipient or the customer may provide the information on behalf of the identification card recipient. Some other information that a customer may provide include the identification card recipient's height, weight, date of birth (and/or age), gender, hair color, skin color, blood type, allergy information, medical indications, medication and dosage information, and other identifying information.

The self-service identification card station may confirm whether there is any required information not submitted by the purchaser. Required information may include name and address. Optional information may include the recipient's hobbies. The self-service identification card station may use asterisks, highlights and other means to identify required information. In addition, the process may not be allowed to continue until the required information is entered. For example, if the user attempts to proceed to a subsequent step without providing required information, the self-service identification card station may present the customer a display stating that not all required information has been entered. In some embodiments, the display highlights the fields that need to be completed. If there is no required information or if all required information has been entered, the purchaser proceeds to the next step 305, which allows the purchaser to provide the identification card recipient's biometric information.

A customer may provide one or more categories of biometric information in step 305, such as pictures, fingerprints, retinal signatures, voice signatures, and other information collected through special biometric information capturing devices, which devices are known in the art and thus not described further here. The purchaser may upload the biometric information from a media storage device or utilize the biometrics input device 160 of the self-service identification card station 100. For example, the customer may be asked if he or she would like to include a picture on the identification card. If the customer selects to include a picture, the display may then allow the customer to upload a picture from a media storage device to the self-service identification card station. The customer may also be given the possibility to utilize a camera on the self-service identification card station to take the picture. The biometric information may be displayed on the card or encoded on the magnetic stripe, RFID Chip, three dimensional barcodes, and other such devices or means as contemplated by a person having ordinary skill in the art for preserving and accessing the biometric information.

Once the customer has entered all information to be placed on the card, including pictures and other biometric information, the customer may be given the option to print the card or to customize the card before printing at step 307. If the purchaser selects to proceed to print the identification card, the self-service identification card station processes the request and directs the purchaser to the payment step 339.

When a customer selects the option to customize an identification card, the customization process may be accomplished in several steps. In one step, the customer may arrange the layout of the card by, for example, changing the location where specific information will be placed. In a second step, the customer may include additional common information on the card. For example, the customer may include emergency numbers and other information on the card based upon the location of the self-service identification card station, the address of the identification card recipient, or other location characteristics that the purchaser selects. The self-service identification card station may provide the phone numbers to the nearest hospitals, police station, child advocacy centers, missing persons offices, and other public interest information. This information may be accessed by the self-service identification card station from local databases to which the self-service identification card station 100 has access through a network and/or internet connections.

In another step of the customization process, the customer may select a background for the card. The self-service order station may present the customer with several background options to print on the card. The purchaser may also be presented with several categories of cards to browse through for selection of a background for the card. A person of ordinary skill in the art will recognize that the display may include, for example, an alphabetical listing of the categories (for example, a list of underlined categories) or a category button display of the categories (such as thumbnails with the category and a related graphic). The purchaser may utilize the keyboard to type the name of the category. The purchaser's entry may then be viewed in a display window. As the purchaser is typing the name of the category, the display may optionally narrow the category buttons (thumbnails) displayed to those that meet the purchaser's input. In other embodiments, the chosen category may be displayed after the purchaser presses an “enter” button. Alternatively, the customer may upload a digital file to be utilized as the background of the identification card. Based upon the information provided about the identification card recipient, the self-service identification card station may present the purchaser with identification card background options that are most closely related to the identification card recipient. For example, when the purchaser enters the intended recipient's location (e.g., where they live), the display to the user may provide themes relevant to such location. The themes associated with that location may include local sports teams, local landmarks, and other local items the identification card purchaser may be interested in using as the background for the card.

In a further step, the customer may be provided with an option of creating a template for subsequent identification cards. In an exemplary embodiment, the identification card templates, which provide the background for the card blanks, include a graphic image that is 1013×638 pixels, configured in horizontal (i.e., landscape) aspect, and stored as uncompressed TIFF or BMP files. Further, each card template other than the “standard card” template may preferably receive data for font, size, color, location, alignment, and drop shadow of user-inputted text. Still further, card templates which require user-selected photos will preferably include an alpha channel mask in which the user's photo will be placed. On the alpha channel, the user image is preferably white on the alpha channel, and the processing software will allow the user to adjust their photo with the mask.

In a further customization step, the self-service identification card station displays both sides of the identification card to the purchaser as it will be printed if accepted. Once the purchaser has reviewed the display of the cards, he or she may select to proceed to the payment step 339. The purchaser may select to purchase a single card or multiple cards. The purchaser may also be given the opportunity to begin the process again for a second card. Before proceeding to create a second card, the purchaser may save or discard the previously created card. Once the purchaser is ready to proceed to purchase one or more cards, he or she may select a check out button on the user interface. The purchaser may select to pay at a counter or at the self-service identification card station. Once the payment is processed, the card is printed at step 333 and the purchaser may retrieve it from the self-service identification card station or from the store's counter.

During the final printing step 333, the identification card may print on one of preferably two separate card printers, a local printer at the self-service identification card station or a network printer in a retail photo lab. The differentiation of what printer to use may be customized based upon what items are being printed. For example, if a customer chooses to print a complex picture on the card, the card may be printed at the network printer at the photo lab. Additionally, information that is not displayed on the card can be encoded on the magnetic stripe or RFID Chip at an encoding step 337. The software may optionally provide a profanity filter that checks text input by the customer against a list of profane words or phrases and keeps the user from entering unacceptable text on the cards. When the profanity filter is enabled, cards that incorporate user generated text may be printed at the local printer at the self-service identification card station. Once the identification card is printed 333 and encoded 337, it is then dispensed to the customer at step 341.

Optionally, customized identification cards may likewise be purchased online but printed at the retail location at which the self-service identification card station is located. Each card is customized and purchased online using a retailer's website or a website associated with the self-service identification card station operator. The card may print remotely at a retail corporate printer for mailing to the customer, at a printer at the self-service identification card station operator's location, or at a local store. These cards may then either be picked up locally or shipped to the recipient. The self-service identification card station also preferably collects payments by printing a receipt, which the customer takes to the nearest cashier to pay for their order, or reads and processes the customer's credit card for payment. Optionally, payment may also be received from cash or credit through a cash or credit card reader on the self-service identification card station.

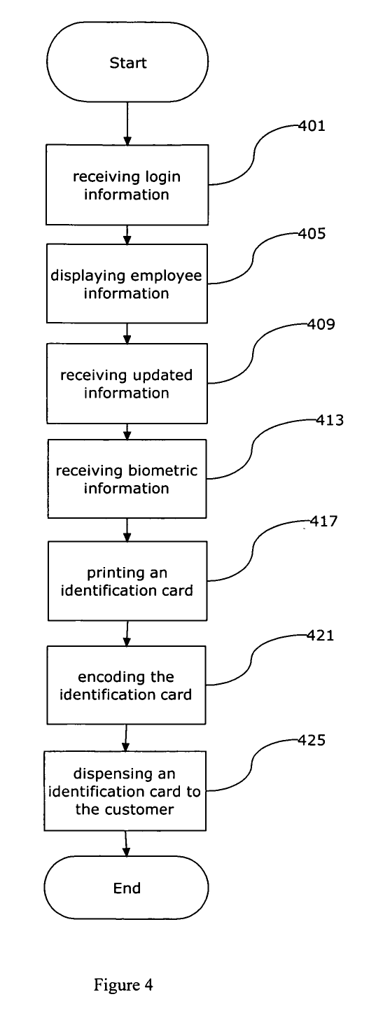

When the self-service identification card station is used in an institutional/corporate setting, the method described in FIG. 4 may be implemented. At step 401, an employee is asked to log-in. The self-service identification card station has access to a network from which login information may be obtained. A database on the network contains employee identification numbers and, when appropriate, access codes. An employee may be given their employee number and access code at, for example, the human resources office. After receiving and confirming the log in information in step 401, the self-serve identification card station displays the employee's identification information obtained from an employee database. The self-service identification card station receives any changes entered by the employee at step 409. In the next step 413, the employee's biometric information is obtained through the biometric capture devices of the self-service identification card station. After the biometric information is obtained, the card is printed on the card at step 417. During the printing step 417, the information required to be visible on the card is printed. At the following step 421, the identification card is encoded with the required authorizations for employee access. For example, the RFID Chip may be encoded to allow access to specific locations. The RFID Chip can then be read by RFID Chip readers placed at specific access points. Similarly, the RFID Chip or magnetic stripe can be encoded to allow access to electronic systems, such as personal and network computers and workstations. Because the cards are stored in the kiosk as blanks, they are not accessible or activated until they are issued to the employee, reducing the possibility of unauthorized issuance of employee identification cards. In addition, the employer has the capability of changing the authorization parameters provided to each employee. For example, if an employee is terminated, access to that specific identification card can be automatically terminated; similarly, if an employee's duties change and require additional authorization to access more restricted locations/information, the authorization profile can be updated without the need of issuing a new card. At the final step 425, the identification card is dispensed and provided to the employee.

The self-service identification card station may also be utilized for printing and issuing gift cards as described in U.S. patent application Ser. No. 12/077,431. It is contemplated that the identification card blanks 140 may be utilized as gift cards and the value of the card added may be included in the card's magnetic stripe or RFID Chip.

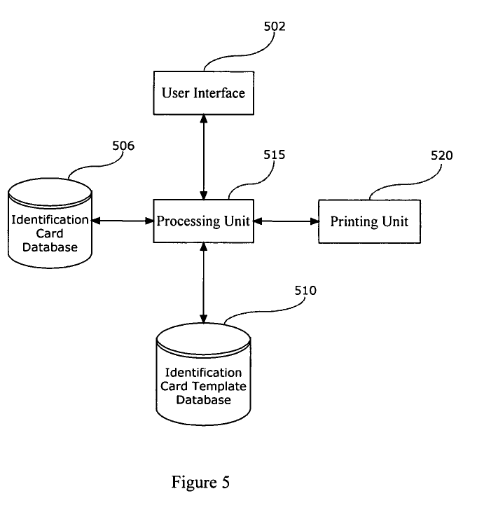

The present invention also includes a system for creating and printing identification cards as shown in FIG. 5. The system may include a user interface 502, an identification card information database 506, an identification card templates database 510, a processing unit 515, and a printing unit 520. The user interface 502 allows the customer to communicate with the system. The identification card information database contains information about specific identification card recipients. The identification card templates database 510 contains different backgrounds and layouts that may be used with different identification cards. The processing unit communicates with each component of the system and coordinates the process of obtaining an identification card.

The identification information database 506 stores specific identification card recipient information. The identification information database 506 may be utilized at a later date to retrieve information about the identification card recipient. For example, if a child is issued an identification card, the information may be stored in the identification information database 506. If the child disappears, the identification information database can be accessed to retrieve information about the missing child and provide that information to the relevant authorities. The information provided to authorities would include the picture of the child and, if recorded, other biometric information that could aid in the search and identification of the identification card.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A self-service identification card station, comprising:
a user interface;
an identification card printer;
a software program, stored in a computer readable medium, comprising instructions for implementing a method of creating and printing an identification card; and
a processing unit communicably connected with the computer readable medium, the user interface, and the card printer;
the processing unit being configured to implement said software program.

2. The self-service identification card station of claim 1, further comprising a biometrics input device communicatively connected with the processing unit.

3. The self-service identification card station of claim 2, wherein said biometrics input device is selected from the group consisting of a digital camera, a fingerprint scanner, and a retinal scanner.

4. The self-service identification card station of claim 1, further comprising:
an encoder communicatively connected with the processing unit.

5. The self-service identification card station of claim 4, wherein the encoder is selected from the group consisting of a magnetic stripe encoder and a RFID Chip encoder.

6. The self-service identification card station of claim 1, wherein the identification card printer further comprises:
an identification card container; and
at least one identification card blank.

7. The self-service identification card station of claim 6, wherein the at least one identification card blank has at least one of a magnetic stripe or a RFID Chip.

8. The self-service identification card station of claim 1, wherein the computer readable medium is a media storage device.

9. The self-service identification card station of claim 1, wherein the identification card printer further comprises at least one of a flash media reader, a CD/DVD drive, a computer keyboard, a receipt printer, a credit card reader, and a cash reader.

10. The self-service identification card station of claim 1, wherein the user interface comprises at least one of a touch screen display, a video screen, and a keyboard.

11. A method for creating and printing identification cards, comprising:
receiving identification information from a customer about an identification card recipient at a self-service identification card station;
receiving biometric information from the identification card recipient at the self-service identification card station;
printing at least some portion of the identification information and at least some portion of the biometric information on an identification card blank; and
presenting an identification card to the customer.

12. The method of claim 11, further comprising:
receiving payment for the identification card.

13. The method of claim 12, wherein the receiving payment step is accomplished at a self-service identification card station or at a counter.

14. The method of claim 11, further comprising:
storing the identification information in an information card database.

15. The method of claim 14, further comprising:
retrieving identification information stored in the identification card database.

16. The method of claim 11, further comprising:
encoding at least some portion of the identification information and at least some portion of the biometric information after the printing step.

17. The method of claim 16, further comprising:
receiving information from a customer before the encoding and printing step to customize the appearance of the identification card.

18. A system for creating and printing identification cards, comprising:
a user interface;
an identification card information database;
a printing unit; and
a processing unit communicatively connected with the user interface, the identification card information database, and the printing unit.

19. The system of claim 17, further comprising an identification card templates database.
